(19) United States
(12) Patent Application Publication
(10) Pub. No.: US 2010/0193508 A1
(43) Pub. Date: Aug. 5, 2010

(54) MICROWAVE DOOR INTERLOCK SWITCH ASSEMBLY

(75) Inventor: Steven Speece, Winnebago, IL (US)

Correspondence Address: HONEYWELL/CST;Patent Services, 101 Columbia Road, P.O. Box 2245, Morristown, NJ, 07962-2245, US

(73) Assignee: Honeywell International Inc.

(21) Appl. No.: 12/364,167

(22) Filed: Feb. 2, 2009

(51) Int. Cl. H05B 6/68

(52) U.S. Cl. 219/722

(57) ABSTRACT

A microwave door interlock switch system and method includes the use of a primary switch and a monitor switch capable of being actuated in sequence via an actuating lever. The primary switch is associated with a primary control circuit that controls the operation of a magnetron associated with a microwave device, while the monitor switch can function as a monitor for verifying the correct state of the primary switch. The interlock switch system can further include a mounting bracket, a base mounting bracket and a compression spring and an adjustment screw. The compression spring adjustment mechanism allows an assembler of the microwave device to fine-tune the location of the interlock switch system during assembly of the microwave device. The switch actuation can be set to occur at a precise point of door closure.

### TECHNICAL FIELD

Embodiments are generally related to microwave devices. Embodiments are also related to interlock switch module for use with microwave devices.

### BACKGROUND OF THE INVENTION

Microwave devices generally include a microwave energy-generating source such as, for example, a magnetron for delivering energy into a cavity defined by a cabinet having a front opening selectively enclosed by a door. Such microwave devices can be utilized as an energy source for cooking food. The magnetron generates microwaves at a particular frequency to interact with molecules in the food, thereby heating the food directly. In such microwave devices, if the cabinet door does not completely close, microwave radiation may leak from the device through a narrow air gap located around the periphery of the door to the microwave device. Leakage of such microwave radiation can adversely affect nearby electronic devices (e.g., a television receiver) and may also be harmful to individuals located near the microwave device. Radiation of such energy beyond the enclosure in certain instances may constitute harmful exposure. Thus, safety standards have been established by regulatory agencies governing the use of such microwave devices.

To prevent the leakage of microwave energy from the cavity during operation of a microwave oven, it is important to positively prevent access to the device cavity when the microwave energy generating means is energized. Thus, an interlocking component for assuring that the cabinet door is in a closed and latched position before the microwave energy generating means is energized is typically utilized in conventional microwave devices.

A number of different interlocking switch assemblies have been developed to provide such functionality. Additionally, such switch assemblies for use with microwave device doors can prevent serious damage to expensive equipment associated with the microwave device, including for example, high voltage supplies. Such switch assemblies are often utilized with particular electrical circuitry to substantially reduce hazards associated with the high voltage supplies. The majority of prior art switch assemblies for microwave device doors that continually carry currents of substantial magnitude may fail in a closed position and thereby render such switch assemblies completely ineffectual as a safety device.

Based on the foregoing, it is believed that a need exists for an improved microwave door interlock switch system capable of preventing the escape and leakage of microwave radiation, as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved interlock switch system for use with a heating appliance in order to assure proper door locking for the confinement of generated heating energy while the heating appliance is energized.

It is another aspect of the present invention to provide for an improved adjustment mechanism capable of setting a switch point precisely when a microwave door is closed.

It is a further aspect of the present invention to provide for a method of manufacturing and/or configuring such a switch system.

The aforementioned aspects and other objectives and advantages can now be achieved as described herein. A microwave door interlock switch system and method of making the same is disclosed, which includes a primary switch and a monitor switch that are actuated in sequence via an actuating lever (e.g., plastic). The primary switch is generally associated with a primary control circuit that controls the operation of a magnetron associated with a microwave device. The monitor switch can function as a monitor to verify the correct state of the primary switch. The interlock switch system further includes a mounting bracket, a base mounting bracket, a compression spring and an adjustment screw. The compression spring adjustment mechanism allows an assembler of the microwave device to fine-tune the location of the interlock switch system during assembly of the microwave device. The switch actuation can be set to occur at a precise point of door closure.

The shape of the actuating lever and the position of the switches ensure that each switch is always operated in a proper sequence. The interlock switch system can be mounted to the side of the microwave door and mounted with screws, when opened, can provide access to the cooking chamber. The contact with the interlock switch system is broken and the interlock switch system deactivates when the door is removed or opened. When the door is closed and contact resumed, the switch system is reactivated. The adjustment mechanism can be utilized to set the switch point precisely when the door is closed, thereby providing an improved door interlock switch system in complying with national and international safety standards while preventing the escape of stray radiation from the microwave device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a microwave door interlock switch system, in which embodiments of the present invention may be implemented;

FIG. 2 illustrates a front view of the microwave door interlock switch system depicted in FIG. 1, in accordance with a preferred embodiment;

FIG. 3 illustrates a left hand assembly of the microwave door interlock switch system, in accordance with a preferred embodiment;

FIG. 4 illustrates a right hand assembly of the microwave door interlock switch system, in accordance with a preferred embodiment;

FIG. 5 illustrates a side view of the compression spring associated with an adjustment screw, which can be implemented in accordance with a preferred embodiment;

FIG. 6 illustrates a simple circuit diagram of the microwave door interlock switch system, which can be implemented in accordance with a preferred embodiment; and

FIG. 7 illustrates a graphical representation illustrating operation of switches associated with the door interlock switch system depicted in FIG. 1, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

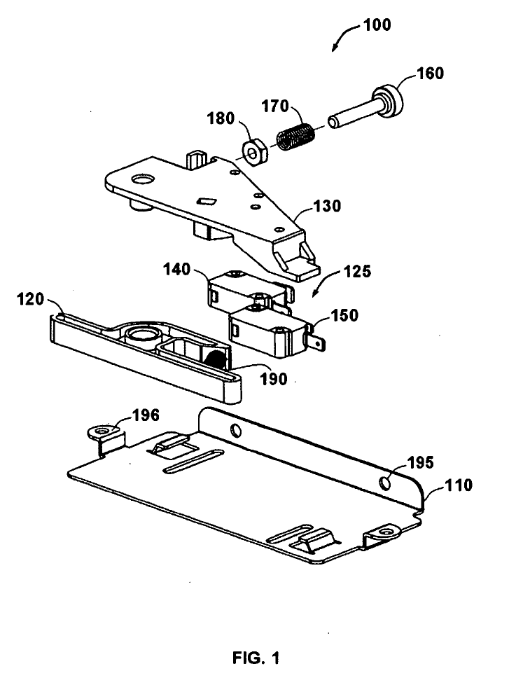

FIG. 1 illustrates a perspective view of a microwave door interlock switch system 100, in which embodiments of the present invention may be implemented. The microwave door interlock switch system 100 generally includes a subassembly 125 comprising a primary switch 150 and a monitor switch 140 that can be actuated in sequence via an actuating lever 120 and mounted on a main mounting bracket 130. The microwave door interlock switch system 100 can be utilized with any type of microwave device equipped with a heavy duty magnetron. Such microwave devices are capable of delivering microwave energy in a high radio frequency band for rapid reheating, cooking and defrosting applications. In general, the microwave device can be equipped with the door interlock switch system 100 in order to interrupt the production of microwave energy when the microwave device door is opened and similarly to prevent any microwave output until the door is firmly and safely closed.

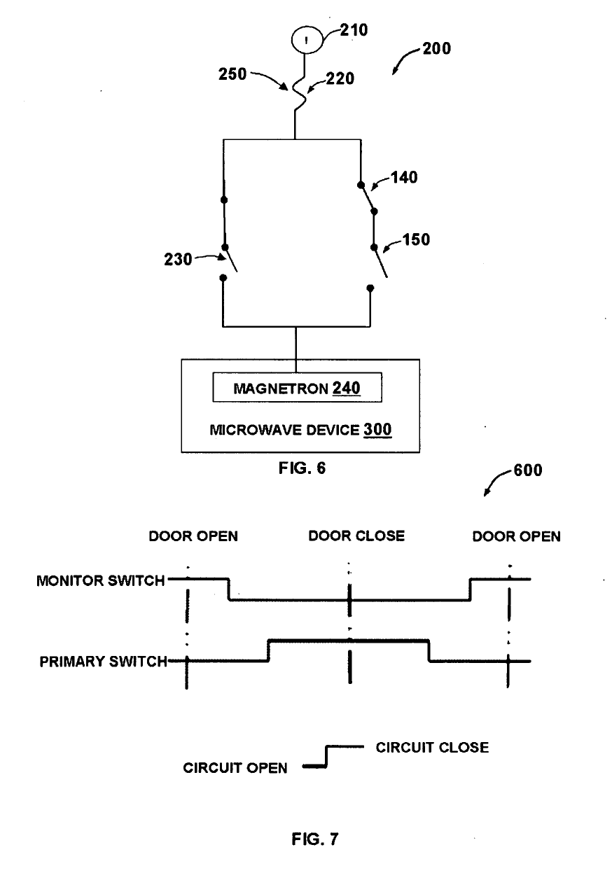

The primary switch 150 is associated with a primary control circuit, such as that depicted in FIG. 6, in order to control the operation of a heat generating source such as, for example, a magnetron 240 associated with a microwave device 300 (see FIG. 6). The monitor switch 140 can function as a monitor to verify the correct state of the primary switch 150. The door interlock switch system 100 can be configured to further include a base mounting bracket 110, a compression spring 170, an adjustment screw 160 and a compression spring adjustment mechanism 190. In some embodiments, an insulator plate may also be provided with respect to the device 300. In a preferred embodiment, for example, the main mounting bracket 130 can be molded in one piece from a plastic or other similar material, depending upon design considerations. The base mounting bracket 110 may be configured from a material such as, for example, sheet metal, again depending upon design considerations. It can be appreciated that other types of materials may be utilized in place of these suggested materials. The interlock switch system 100 can be mounted to the side of the microwave device 300 utilizing a pair of holes 195, 196 provided and/or configured in the base-mounting bracket 110.

The primary switch 150 and the monitor switch 140 can be actuated in sequence via the actuating lever 120. Note that the actuating lever 120 may be configured from a material such as, for example, plastic, or another suitable material. The actuating lever 120 can further interface with a door of the microwave device 300, and when opened, provide access to the cooking chamber of the device 300. The contact with the interlock switch system 100 can be broken and the interlock switch system 100 deactivated when the door cover is removed or opened. When the door is closed and contact resumed, the switch system 100 is reactivated.

The compression spring adjustment mechanism 190 accomplished via the adjustment screw 160 and the compression spring 170 can be utilized to set the switch point precisely when the door is closed. The compression spring adjustment mechanism 190 can be utilized to adjust the position of the subassembly 125 comprising the actuating lever 120, the main mounting bracket 130, the primary switch 150 and the monitor switch 140. The compression spring adjustment mechanism 190 maintains the position of the primary switch 150 and the monitor switch 140 relative to the actuating lever 120 after adjustment in order to actuate each switch 140 and 150 in a proper sequence.

Note that the embodiments discussed herein should not be construed in any limited sense. It can be appreciated, however, that such embodiments can be implemented in the context of other devices and designs, and are not limited to the microwave device and may be subject to change by skilled persons within the scope of the invention without departing from the concept thereof.

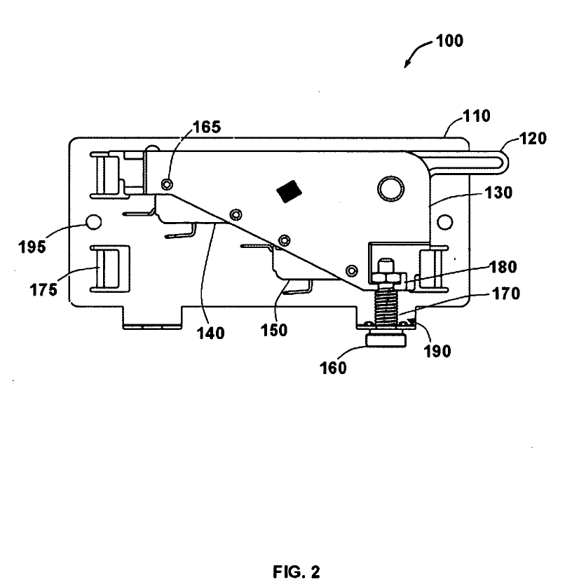

FIG. 2 illustrates a front view of the microwave door interlock switch system 100 depicted in FIG. 1, which can be implemented in accordance with a preferred embodiment. Note that in FIGS. 1-7, identical or similar blocks are generally indicated by identical reference numerals. The actuating lever 120 along with the primary switch 150 and the monitor switch 140 can be utilized to maintain the door of microwave device 300 in a closed position.

The independent safety switches 140 and 150 can interrupt power to the magnetron 240 by two separate mechanical means when the microwave device door is opened. In the preferred embodiment, the primary switch 150 associated with appropriate electrical control means such as shown in FIG. 6 can be utilized to permit energization of the magnetron 240 only if the door of the microwave device 300 is tightly closed. Upon unlatching and opening the door of the microwave device 300, the switches 140 and 150 can be deactivated and the magnetron 240 is de-energized.

The primary switch 150 associated with the primary control circuit 200 of FIG. 6 can enable\disable the control system of the microwave device 300 in response to closing and opening the door respectively. The shape of the plastic actuating lever 120 and the position of the primary switch 150 and the monitor switch 140 can ensure proper operation sequence of the microwave door interlock switch system 100. The door interlock switch system 100 can be fastened to the right side or to the left side of the microwave device 300 utilizing mounting holes, such as holes 195, 196 associated with the base mounting bracket 110, with respect to the alignment of the microwave device door.

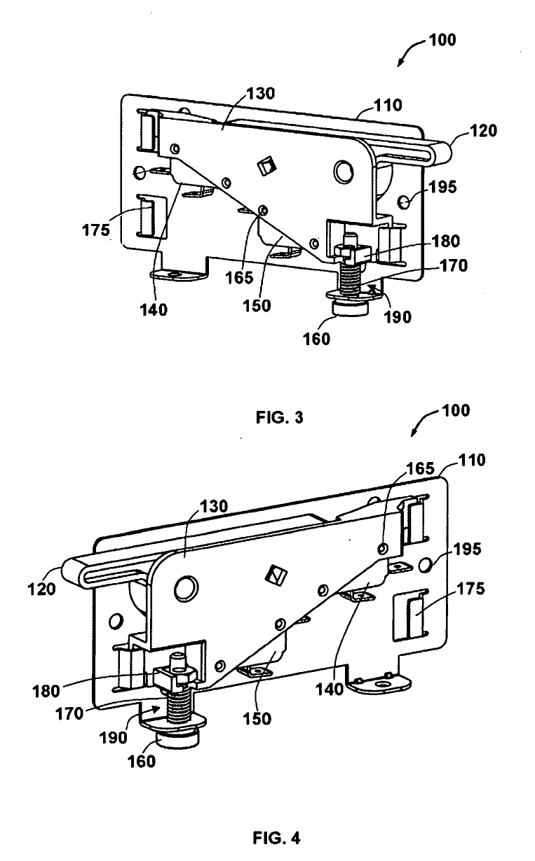

FIG. 3 illustrates a left hand assembly of the door interlock switch system 100 depicted in FIG. 1, which can be implemented in accordance with a preferred embodiment. FIG. 4 illustrates a right hand assembly of the door interlock switch system 100 depicted in FIG. 1, which can be implemented in accordance with a preferred embodiment. These views are described for purposes of clarity and specificity; however, they should not be interpreted in any limiting manner. The door interlock switch system 100 can be arranged to provide a positive latching of the door in the closed position and to prevent energization of the microwave energy generating device (e.g., magnetron 240), when the door is in an open position. The door interlock switch system 100 permits control to effect operation of the device 300 only when the door is in the closed and latched position.

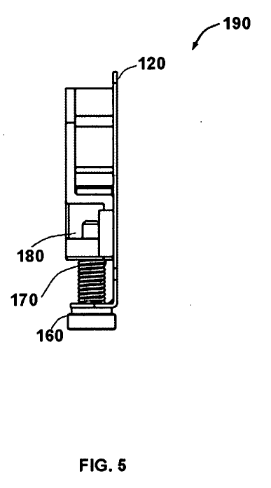

FIG. 5 illustrates a side view of the compression spring 170 associated with the adjustment screw 160, in accordance with a preferred embodiment. The adjustment screw 160 and the spring 170 can be adjusted to set the switch actuation operation to occur at the precise point of door closure. The switches 140 and 150 and the actuating lever 120 can be mounted secured to the mounting plate 130 via posts in the mounting plate 130, which itself is secured to the door release mounting bracket 110 via the adjustment screw 160, the compression spring 170 and the nut 180. The adjustment mechanism 190 allows the subassembly 125 of the microwave device 300 to fine-tune the location of the mounting plate 130, actuating lever 120 and the switches 140 and 150 during assembly of the microwave device 300. The spring 170 associated with the adjustment screw 160 can provide a sufficient force to maintain the subassembly 125 in position after adjustment. The adjustment mechanism 190 includes a nut 180, which can be a plain-shaped nut, a hexagonal shaped nut, or a nut having another appropriate shape depending upon design considerations. The nut 180 is contained in the mounting plate 130 and can be utilized to associate the adjustment screw 160 and the spring 170 with the subassembly 125.

FIG. 6 illustrates a simple circuit diagram of a primary control circuit 200 that includes electrical components of the door interlock switch system 100, in accordance with an alternative embodiment. Again as reminder, in FIGS. 1-7, identical or similar blocks are generally indicated by identical reference numerals. As indicated in FIG. 6, the primary switch 150 of the door switch system 100 is associated with the primary control circuit 200, which controls the operation of the magnetron 240 of the microwave device 300. Circuit 200 of the door switch assembly 100 includes a power supply part 210 capable of supplying an electric power to the magnetron 240 of the microwave device 300. Additionally, a commercial current line 250 generates high-voltages based on the electric power supply from the power supply part 210 by forming a closed loop thereof. The magnetron 240 can generate electromagnetic waves based on the high-voltages generated by the current line 250.

The current line 250 can be provided with a fuse 220 that prevents an over current from being supplied to the magnetron 240 if the primary switch 150 fails. The monitor switch 140 and the primary switch 150 of the door switch assembly 100 can be connected in series to the power supply part 210 within the commercial current line 250. On the closed loop, the primary switch 150 can be connected and closed when the door of the microwave device 300 is closed. Also, the monitor switch 140 can be operated in reverse relative to the operation of the primary switch 150. With this configuration, while the door of the microwave device 300 is closed, the primary switch 150 can be maintained in a closed state.

A secondary switch 230 can be in a closed state if external closing signals are provided (i.e., when the primary switch 150 is closed). At this instance, the monitor switch 140 can be in an open state, thereby permitting the electric power from the power supply part 210 to be supplied to the magnetron 240. The electromagnetic waves generated by the magnetron 240 based on the supplied electric power can be supplied into the chamber of the microwave device 300. When the door of the microwave device 300 is opened, however, the primary switch 150 is maintained in an open state. Thus, irrespective of whether the secondary switch 230 is opened or closed, the electric power to be supplied to the magnetron 240 can be terminated. Consequently, the number of necessary switches may be decreased and the circuit structure 200 simplified. With such a configuration, the cost of production can be lowered and the stability of circuit 200 improved.

Note that there are many different types of microwave devices, which can be utilized to implement microwave device 300. For example, one type of microwave device that may be modified for use as microwave device 300 is disclosed in U.S. Pat. No. 7,091,458, entitled “Door Assembly for Microwave Oven,” which issued to Lee et al on Aug. 15, 2006. U.S. Pat. No. 7,091,458 is incorporated herein by reference. Another type of microwave device, which may be modified for use as microwave device 300, is disclosed in U.S. Patent Application Publication No. US20050194380 entitled “Microwave Oven,” which published on Sep. 8, 2005 and was invented by inventors Ho Kim et al. U.S. Patent Application Publication No. US20050194380 is also incorporated herein by reference. A further example of a microwave device that may be modified for use as microwave device 300 is disclosed in U.S. Pat. No. 7,053,348, entitled “Microwave Oven,” which issued to Tereda et al on May 30, 2006. U.S. Pat. No. 7,053,348 is incorporated herein by reference. It is understood that such microwave devices represent merely non-limiting examples of some types of devices that may be modified for use with alternative embodiments.

FIG. 7 illustrates a graph 600 depicting the operation of switches associated with the door interlock switch system 100 depicted in FIG. 1, in accordance with a preferred embodiment. When the door of the microwave device 300 is open, the monitor switch 140 remains closed and the primary switch 150 remains opened. Similarly, when the door is in a closed position, the primary switch 150 remains closed and monitor switch 140 is opened. Thus, the electrical current from the power supply part 210 can be supplied to the magnetron 240 of the microwave device 300. As apparent from the above description, aspects of the present invention provide the door interlock switch system 100 for microwave device 300, so that the adjusting mechanism 190 can be utilized to precisely position the subassembly 125, thereby providing an improved door interlock switch system 100 complying with national and international safety standards and ensuring escape of stray radiations from the microwave device 300.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A microwave door interlock switch system for a microwave device having a door, comprising:
a primary switch associated with a primary control circuit for controlling a heat generating source associated with said microwave device, wherein said heat generating source does not operate unless said primary control circuit of said primary switch is in a closed position;
a monitor switch for monitoring a correct state of said primary switch, wherein said primary switch and said monitor switch are respectively sequentially opened and closed in response to an opening of said door;
an actuating lever for actuating said primary switch and said monitor switch in a particular sequence, wherein said actuating lever interfaces with said door of said microwave device, thereby preventing a release of radiation from said microwave device; and
an adjustment mechanism associated with the actuating lever for adjusting a switch point of said primary switch and/or said monitor switch, wherein said adjustment mechanism can be used to set the switch point of said primary switch and/or said monitor switch precisely when said door of said microwave device is in a closed position.

2. The microwave door interlock switch system of claim 1 wherein said primary switch, said monitor switch, and said actuating lever comprise a subassembly.

3. The microwave door interlock switch system of claim wherein the adjustment mechanism comprises:
an adjustment screw and a compression spring configured to adjust said position of said subassembly such that said primary switch and said monitor switch are actuated in a proper sequence relative to said actuating lever after adjustment.

4. (canceled)

5. The microwave door interlock switch system of claim 1 further comprising:
a mounting bracket for mounting said primary switch, said secondary switch, and said actuating lever; and
a base mounting bracket mounted to a side of said door associated with said microwave device utilizing at least one mounting screw.

6. The microwave door interlock switch system of claim 5, wherein said actuating lever comprises a plastic material.

7. The microwave door interlock switch system of claim 6, wherein said mounting bracket comprises a plastic material.

8. The microwave door interlock switch system of claim 5, wherein said base mounting bracket comprises sheet metal.

9. The microwave door interlock switch system of claim 1 further comprising a fuse associated with said primary control circuit wherein said fuse prevents a flow of current if said primary switch remains closed when said monitor switch is closed.

10. The microwave door interlock switch system of claim 1 further comprising a power supply for supplying an electric power to said heat generating source of said microwave device.

11. The microwave door interlock switch system of claim 1 wherein said heat generating source comprises a magnetron.

12. A microwave door interlock switch system for a microwave device having a door, comprising:
a primary switch associated with a primary control circuit for controlling a heat generating source associated with said microwave device, wherein said heat generating source does not operate unless said primary control circuit of said primary switch is in a closed position;
a monitor switch for monitoring a correct state of said primary switch, wherein said primary switch and said monitor switch are respectively sequentially opened and closed in response to an opening of said door;
an actuating lever for actuating said primary switch and said monitor switch in a particular sequence; and
a subassembly that includes said primary switch, said monitor switch, and said actuating lever, wherein said actuating lever interfaces with said door of said microwave device, thereby preventing a release of radiation from said microwave device.

13. The microwave door interlock switch system of claim 12 further comprising:
an adjustment screw and a compression spring configured to adjust said position of said subassembly, thereby actuating said primary switch and said monitor switch in a proper sequence relative to said actuating lever after adjustment, wherein said compression spring sets a switch point precisely when said door of said microwave device is in a closed position.

14. A method of configuring a microwave door interlock switch system for a microwave device having a door, said method comprising:
associating a primary switch with a primary control circuit for controlling a heat generating source associated with a microwave device, wherein said heat generating source does not operate unless said primary control circuit of said primary switch is in a closed position;
monitoring a correct state of said primary switch utilizing a monitor switch, wherein said primary switch and said monitor switch are respectively sequentially opened and closed in response to an opening of said door; and
utilizing an actuating lever to actuate said primary switch and said monitor switch in a particular sequence, wherein said actuating lever interfaces with said door of said microwave device, thereby preventing a release of radiation from said microwave device.

15. The method of claim 14 further comprising providing a subassembly that includes said primary switch, said monitor switch, and said actuating lever.

16. The method of claim 15 further comprising:
manipulating an adjustment screw and a compression spring to adjust said position of said subassembly, thereby actuating said primary switch and said monitor switch in a proper sequence relative to said actuating lever after adjustment.

17. The method of claim 16 further comprising manipulating said compression spring to set a switch point precisely when said door of said microwave device is in a closed position.

18. The method of claim 14 further comprising:
providing a mounting bracket for mounting said primary switch, said secondary switch, and said actuating lever; and
connecting a base mounting bracket to a side of said door associated with said microwave device utilizing at least one mounting screw.

19. The method of claim 14 wherein said actuating lever comprises a plastic material, said mounting bracket comprises a plastic material, and said base mounting bracket comprises sheet metal.

20. The method of claim 14 further comprising:
associating a fuse with said primary control circuit wherein said fuse prevents a flow of current if said primary switch remains closed when said monitor switch is closed; and
providing a power supply for supplying an electric power to said heat generating source of said microwave device.
